(19) United States
(12) Patent Application Publication
(10) Pub. No.: US 2021/0356290 A1
(43) Pub. Date: Nov. 18, 2021

(54) METHOD AND APPARATUS FOR RECOMMENDING POINT OF INTEREST, DEVICE, AND MEDIUM

(71) Applicant: BEIJING BAIDU NETCOM SCIENCE AND TECHNOLOGY CO., LTD., Beijing (CN)

(72) Inventors: Jingbo ZHOU, Beijing (CN); Hui XIONG, Beijing (CN)

(73) Assignee: BEIJING BAIDU NETCOM SCIENCE AND TECHNOLOGY CO., LTD., Beijing (CN)

(21) Appl. No.: 17/386,302

(22) Filed: Jul. 27, 2021

(30) Foreign Application Priority Data
Sep. 14, 2020 (CN) 202010961980.7

(51) Int. Cl. G01C 21/36

(52) U.S. Cl. CPC G01C 21/3682; G01C 21/3617

(57) ABSTRACT

A method for recommending a point of interest (POI) includes: generating a user explicit feature based on a user profile of a user to be recommended; generating a POI explicit feature based on a POI profile of each candidate POI in a pre-constructed POI hierarchical structure; generating a historical interaction feature based on historical interaction behaviors of the user to be recommended to each candidate POI; determining a matrix of recommending values for each hierarchy based on at least one of the user explicit feature, the POI explicit feature and the historical interaction feature in combination with an association relationship between inter-hierarchy candidate POIs and/or intra-hierarchy candidate POIs in the POI hierarchical structure; and selecting at least one target POI from the candidate POIs of each hierarchy based on the matrix of recommending values for each hierarchy.

### CROSS-REFERENCE TO RELATED APPLICATION

This application is based upon and claims a priority to Chinese Patent Application No. 202010961980.7, filed with the State Intellectual Property Office of P.R. China on Sep. 14, 2020, the entire contents of which are incorporated herein by reference.

### FIELD

The disclosure relates to a field of artificial intelligence and information recommending technologies, and particularly relates to a method and an apparatus for recommending a point of interest (POI), a device, and a medium.

### BACKGROUND

In order to enhance a service function of a product related to a location based service (LBS), the LBS product is generally set up with a function for recommending a point of interest (POI), i.e., for recommending a POI to a user, thereby reducing time costs for the user to select from multiple POIs.

However, in the related art, an accuracy of a recommending result is poor when the POI recommendation is performed, thereby reducing the user experience.

### SUMMARY

According to an aspect of the disclosure, a method for recommending a point of interest (POI) is provided. The method includes: generating a user explicit feature based on a user profile of a user to be recommended; generating a POI explicit feature based on a POI profile of each candidate POI in a pre-constructed POI hierarchical structure, in which a parent POI node at a high hierarchy spatially covers each child POI node at a low hierarchy; generating a historical interaction feature based on historical interaction behaviors of the user to be recommended to each candidate POI; determining a matrix of recommending values for each hierarchy based on at least one of the user explicit feature, the POI explicit feature and the historical interaction feature, in combination with an association relationship between inter-hierarchy candidate POIs and/or intra-hierarchy candidate POIs in the POI hierarchical structure; and selecting at least one target POI from the candidate POIs of each hierarchy for recommendation based on the matrix of recommending values for each hierarchy.

According to another aspect of the disclosure, a method for recommending a point of interest (POI) is provided. The method includes: generating a sample user explicit feature based on a user profile of a sample user; generating a sample POI explicit feature based on a POI profile of each candidate sample POI in a pre-constructed POI hierarchical structure, in which a parent POI node space at a high hierarchy spatially covers each child node POI at a low hierarchy; generating a sample historical interaction feature based on historical interaction behaviors of the sample user to each candidate sample POI; determining a sample matrix of recommending values for each hierarchy by inputting at least one of the sample user explicit feature, the sample POI explicit feature and the sample historical interaction feature to a pre-constructed POI recommending model, in combination with an association relationship between inter-hierarchy candidate sample POIs and/or intra-hierarchy candidate POIs in the POI hierarchical structure; and adjusting a network parameter in the pre-constructed POI recommending model based on the sample historical interaction feature and the sample matrix of recommending values.

According to another aspect of the disclosure, an apparatus for recommending a point of interest (POI) is provided. The apparatus includes at least one processor and a memory configured to store instructions executable by the at least one processor. The at least one processor is configured to generate a user explicit feature based on a user profile of a user to be recommended; generate a POI explicit feature based on a POI profile of each candidate POI in a pre-constructed POI hierarchical structure; generate a historical interaction feature based on historical interaction behaviors of the user to be recommended to each candidate POI; determine a matrix of recommending values for each hierarchy based on at least one of the user explicit feature, the POI explicit feature and the historical interaction feature, in combination with an association relationship between inter-hierarchy candidate POIs and/or intra-hierarchy candidate POIs in the POI hierarchical structure; and select at least one target POI from the candidate POIs of each hierarchy for recommendation based on the matrix of recommending values for each hierarchy. A parent POI node space at a high hierarchy spatially covers each child POI node at a low hierarchy.

It should be understood that, the contents described in the Summary are not intended to identify key or important features of embodiments of the disclosure, nor is it intended to limit the scope of the disclosure. Other features of the disclosure will become apparent from the following description.

### BRIEF DESCRIPTION OF THE DRAWINGS

The accompanying drawings herein are used for better understanding the solution and do not constitute a limitation of the disclosure.

FIG. 1A is flow chart illustrating a method for recommending a point of interest according to embodiments of the disclosure.

FIG. 1B is a structural schematic diagram illustrating a point of interest tree according to embodiments of the disclosure.

FIG. 2 is a flow chart illustrating another method for recommending a point of interest according to embodiments of the disclosure.

FIG. 3 is a flow chart illustrating another method for recommending a point of interest according to embodiments of the disclosure.

FIG. 4 is a flow chart illustrating another method for recommending a point of interest according to embodiments of the disclosure.

FIG. 5A is a flow chart illustrating another method for recommending a point of interest according to embodiments of the disclosure.

FIG. 5B is a structural schematic diagram illustrating a point of interest tree according to embodiments of the disclosure.

FIG. 5C is a structural schematic diagram illustrating a point of interest context map according to embodiments of the disclosure.

FIG. 5D is a structural schematic diagram illustrating a POI recommending model according to embodiments of the disclosure.

FIG. 6 is a block diagram illustrating an apparatus for recommending a point of interest according to embodiments of the disclosure.

FIG. 7 is a block diagram illustrating another apparatus for recommending a point of interest according to embodiments of the disclosure.

FIG. 8 is a block diagram illustrating an electronic device capable of implementing a method for recommending a point of interest according to embodiments of the disclosure.

### DETAILED DESCRIPTION

Description will be made below to exemplary embodiments of the disclosure with reference to accompanying drawings, which includes various details of embodiments of the disclosure to facilitate understanding and should be regarded as merely examples. Therefore, it should be recognized by the skilled in the art that various changes and modifications may be made to the embodiments described herein without departing from the scope of the disclosure. Meanwhile, for clarity and conciseness, descriptions for well-known functions and structures are omitted in the following description.

A method and an apparatus for recommending a point of interest (POI) according to embodiments of the disclosure are applied to a situation where multi-hierarchy POI recommendation is performed for a user when the user uses an LBS (location based service) product in a field of information recommending technologies. The method for recommending the POI according to embodiments of the disclosure may be executed by the apparatus for recommending the POI. The apparatus is implemented in software and/or hardware, and configured in an electronic device.

In order to clearly introduce the technical solution of embodiments of the disclosure, description will be made in detail firstly to a POI hierarchy structure involved in the disclosure.

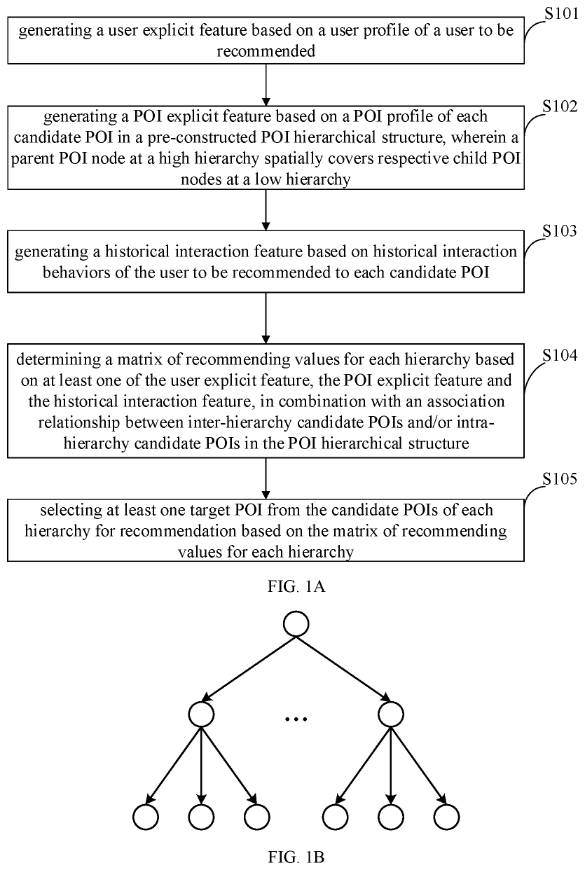

FIG. 1A is flow chart illustrating a method for recommending a point of interest according to embodiments of the disclosure. The method includes the following blocks S101-S105.

At block S101, a user explicit feature is generated based on a user profile of a user to be recommended.

The user profile is configured to characterize basic attributes of the user, and may include at least one of a name, an account name, a gender, an age, an occupation, a hobby or the like.

Accordingly, encoding processing is performed on the user profile of the user to be recommended to generate a structured user explicit feature. The encoding processing is configured to convert text data into numerical data, and may be implemented by any encoding model in the related art, which is not limited in the disclosure.

At block S102, a POI explicit feature is generated based on a POI profile of each candidate POI in a pre-constructed POI hierarchical structure. A parent POI node at a high hierarchy spatially covers respective child POI nodes at a low hierarchy.

The POI hierarchical structure may be implemented in a form of a storage structure such as a tree, or a table. A POI tree is taken as an example, and please refer to a structural schematic diagram of the POI tree illustrated in FIG. 1B. In the POI tree, each node represents a POI, and a connection relationship between the parent node and its corresponding child node characterizes that the parent POI node covers its corresponding child POI node in a physical space. For example, when a park B is set in a city A, the park B is a child node of the city A, and the city A is the parent node of the park B in the POI tree. For another example, when a restaurant C is set in the park B, the restaurant C is the child node of the park B, and the park B is the parent node of the restaurant C in the POI tree.

The POI profile is configured to characterize basic attributes of the POI, including at least one of a POI type, a geographical location, a visited user category or the like.

Accordingly, encoding process is performed on the POI profile in each candidate POI to generate a structured POI explicit feature. The encoding process is configured to convert the text data into the numerical data, and may be implemented by any encoding model in the related art, which is not limited in the disclosure.

It should be noted that the way for generating the POI explicit feature may be the same as or different from the way for generating the user explicit feature.

At block S103, a historical interaction feature is generated based on historical interaction behaviors of the user to be recommended to each candidate POI.

The historical interaction behavior is configured to characterize an interaction situation of the user to be recommended to each candidate POI before the POI recommendation is performed. An interaction behavior may be at least one of searching, visiting and recommending.

In detail, historical interaction data is generated based on the historical interaction behavior of the user to be recommended to each candidate POI. The encoding processing is performed on the historical interaction data to generate a structured historical interaction feature. For example, when the user has visited a certain candidate POI, a value corresponding to said candidate POI in the historical interaction feature is 1, otherwise the value corresponding to said candidate POI is 0.

At block S104, a matrix of recommending values for each hierarchy is determined based on at least one of the user explicit feature, the POI explicit feature and the historical interaction feature, in combination with an association relationship between inter-hierarchy candidate POIs and/or intra-hierarchy candidate POIs in the POI hierarchical structure.

The historical interaction structure may characterize a historical interaction situation of the user to each candidate POI. The interaction behavior of the user to each candidate POI may be caused by multiple implicit factors, such as a user preference, a similarity of the historically interacted POIs, a similarity between visiting users, transitivity of an interest degree of the child POI node to an interest degree of the parent POI node, and influence among respective child nodes of the same parent node. Therefore, implicit information in the historical interaction feature may be mined based on the user explicit feature and the POI explicit feature, in combination with the association relationship between the inter-hierarchy candidate POIs and/or the association relationship between intra-hierarchy candidate POIs in the POI hierarchical structure. Then, an interest degree of the user to each candidate POI is mapped based on the mined implicit information, the interest degree is taken as a recommending value to form a matrix of recommending values, and the matrix of recommending values may be configured as a reference for the POI recommendation.

The term “inter-hierarchy candidate POIs” herein means that the hierarchy where one candidate POI is located is different from that the hierarchy where the other candidate POI is located. The term “intra-hierarchy candidate POIs” herein means that all the candidate POIs are located at the same hierarchy.

At block S105, at least one target POI is selected from the candidate POIs of each hierarchy for recommendation based on the matrix of recommending values for each hierarchy.

For the candidate POIs of each hierarchy, at least one candidate POI in the hierarchy is selected as the target POI based on the recommending value i.e., the interest degree, of each candidate POI in the matrix of recommending values of each hierarchy, and recommended to the user to be recommended.

In the embodiments of the disclosure, by introducing the POI hierarchical structure and combining with the association relationship between the inter-hierarchy candidate POIs and/or the association relationship between the intra-hierarchy candidate POIs in the POI hierarchical structure when the POI recommendation is performed, a sparsity problem caused by information isolation during the POI recommendation for a single hierarchy is avoided, further thereby improving accuracy of a POI recommending result. Meanwhile, when the POI recommendation is performed, mixed recommending for multi-hierarchy POIs is performed, without building a recommending model for single-hierarchy POIs, thereby improving the comprehensiveness and hierarchy of the POI recommending result.

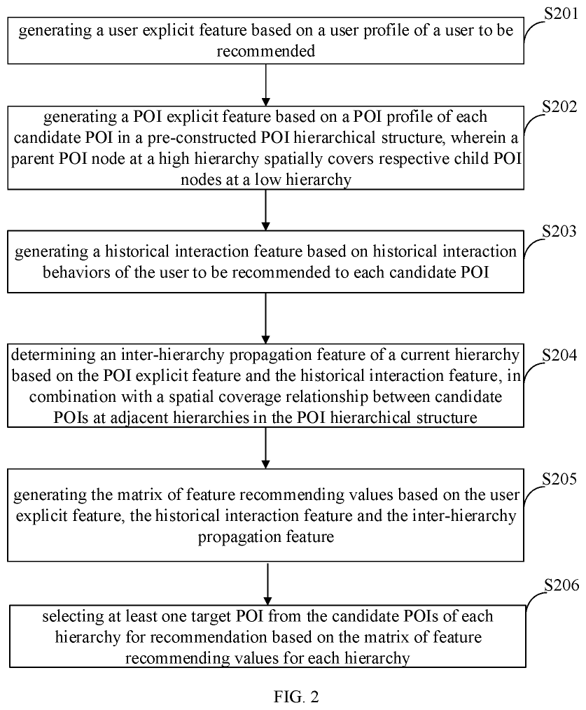

FIG. 2 is a flow chart illustrating another method for recommending a point of interest according to embodiment of the disclosure. The method is optimized and improved on the basis of the technical solution of the above embodiment.

Further, the matrix of recommending values is refined to include a matrix of feature recommending values. Correspondingly, the operation “determining the matrix of recommending values for each hierarchy based on the at least one of the user explicit feature, the POI explicit feature and the historical interaction feature, in combination with the association relationship between the inter-hierarchy candidate POIs in the POI hierarchical structure” is refined into the operation “determining an inter-hierarchy propagation feature of a current hierarchy based on the POI explicit feature and the historical interaction feature, in combination with a spatial coverage relationship between candidate POIs at adjacent hierarchies in the POI hierarchical structure; and generating the matrix of feature recommending values based on the user explicit feature, the historical interaction feature and the inter-hierarchy propagation feature”, to perfect a generating mode of the matrix of feature recommending values.

The method for recommending the POI illustrated in FIG. 2 includes the following blocks S201-S206.

At block S201, a user explicit feature is generated based on a user profile of a user to be recommended.

At block S202, a POI explicit feature is generated based on a POI profile of each candidate POI in a pre-constructed POI hierarchical structure. A parent POI node at a high hierarchy spatially covers respective child POI nodes at a low hierarchy.

At block S203, a historical interaction feature is generated based on historical interaction behaviors of the user to be recommended to each candidate POI.

At block S204, an inter-hierarchy propagation feature of a current hierarchy is determined based on the POI explicit feature and the historical interaction feature, in combination with a spatial coverage relationship between candidate POIs at adjacent hierarchies in the POI hierarchical structure.

In detail, the implicit information associated with the candidate POIs at the adjacent hierarchies in the historical interaction feature is transmitted from the low hierarchy where the child POI node is located to the high hierarchy where the parent POI node is located based on the spatial coverage relationship between the candidate POIs at the adjacent hierarchies in the POI hierarchical structure, thereby implementing the transmission of the information associated with the POI at the low hierarchy to the high hierarchy, and improving the richness of reference content when the POI recommendation is performed at the high hierarchy.

It should be noted that, the inter-hierarchy propagation feature of the current hierarchy may be determined by transmitting information of at least one reduced hierarchy in the adjacent hierarchies to the current hierarchy. For example, when the current hierarchy is the third hierarchy, the information from the fourth hierarchy to the seventh hierarchy (the greater the hierarchy number, the lower the hierarchy is) is transmitted to the third hierarchy to enrich the information in the third hierarchy.

Of course, in order to avoid information interference caused by the information transmitted from other hierarchies far away from the current hierarchy to affect the accuracy of a final POI recommending result, information of a lower hierarchy adjacent to the current hierarchy is generally transmitted. For example, when the information from the fourth hierarchy to the seventh hierarchy is transmitted to the third hierarchy, there are much interference information in the transmitted information because the information from the fifth hierarchy to the seventh hierarchy is not highly correlated with the third hierarchy. Therefore, only the information from the fourth hierarchy is generally transmitted to the third hierarchy.

In an alternative implementation, determining the inter-hierarchy propagation feature of the current hierarchy based on the POI explicit feature and the historical interaction feature, in combination with the spatial coverage relationship between the candidate POIs at the adjacent hierarchies in the POI hierarchical structure may include: generating a POI implicit feature based on the historical interaction feature; and generating a POI inter-hierarchy propagation feature of the parent POI node based on a POI implicit feature of each child POI node in the POI hierarchical structure.

The POI implicit feature may be understood as a POI additional attribute corresponding to the interaction behavior of the user to the candidate POIs, and may include POI environment atmosphere, an implicit relationship between the user and the POI, and the like. For example, the user often goes to a library probably because the transportation near the library is convenient, the library environment is quiet, or other reasons. The above reasons are different from the basic attributes of the POI but directly affect the interaction behavior of the user to the candidate POIs. Therefore, feature extraction needs to be performed on the historical interaction feature in a POI dimension, and the extracted feature is taken as the POI implicit feature to assist in the POI recommendation, thereby improving the richness of the reference content in the POI recommendation.

It may be understood that, since the basic attribute of the POI does not change generally, for example, a park type of POIs does not change to a residence type of POIs, the POI implicit feature is generally transmitted when the information associated with the POI at the low hierarchy is transmitted to the high hierarchy. Therefore, for the POI implicit features of the child POI nodes in the adjacent hierarchies, the POI inter-hierarchy propagation feature of the parent POI node may also be generated to assist in the POI recommendation, thereby further improving the richness of the reference content in the POI recommendation.

Alternatively, generating the POI inter-hierarchy propagation feature of the parent POI node based on the POI implicit feature of each child POI node in the POI hierarchical structure may include: summing the POI implicit features of respective child POI nodes in the POI hierarchical structure; and determining the summed value as the POI inter-hierarchy propagation feature of the parent POI node.

In order to improve the accuracy of the determined POI inter-hierarchy propagation feature, and then lay a foundation for improving the accuracy of POI subsequent recommending results, an attention mechanism may also be introduced to determine the POI inter-hierarchy propagation feature.

Exemplarily, a propagation weight of each child POI node is determined based on the POI implicit feature of the child POI node associated with the parent POI node in the POI hierarchical structure. The POI inter-hierarchy propagation feature of the parent POI node is determined based on the propagation weight and the POI implicit feature of each child POI node.

Exemplarily, for each candidate POI at the current hierarchy, the POI implicit feature of each child POI node of the candidate POI is processed respectively with an activation function. An initial weight of each child POI node is generated based on the processing result. Normalization processing is performed on the initial weight to obtain a propagation weight. Based on a sum of the POI implicit features of child POI nodes weighted with their corresponding propagation weights, a summed matrix is obtained and taken as the POI inter-hierarchy propagation feature of the candidate POI.

The activation function may include at least one of functions such as a sigmoid function, a tan h function, and a ReLu function, which is not limited here. A normalization function in the normalization processing may also be any one or more of normalization functions in the related art, which is not limited here.

In detail, generating the initial weight of each child POI node based on the processing result may be implemented by performing operation on the processing result of each child node POI based on the trained POI inter-hierarchy propagation parameters by employing a preset weight formula. The preset weight formula is determined by the skilled in the art based on an empirical value, or determined through a large number of experiments.

At block S205, the matrix of feature recommending values is generated based on the user explicit feature, the historical interaction feature and the inter-hierarchy propagation feature.

Exemplarily, a POI association feature is generated based on the POI explicit feature, the POI implicit feature and the POI inter-hierarchy propagation feature. A user implicit feature is generated based on the historical interaction feature. A user association feature is generated based on the user explicit feature, the user implicit feature and a user inter-hierarchy propagation feature. The matrix of feature recommending values is generated based on the POI association feature and the user association feature.

Exemplarily, generating the POI association feature based on the POI explicit feature, the POI implicit feature and the POI inter-hierarchy propagation feature may include: performing feature merging on the POI explicit feature, the POI implicit feature and the POI inter-hierarchy propagation feature to obtain the POI association feature. The feature merging may be in a form of superposing or splicing the features.

In order to enable different types of POI features to play a synergistic role in the POI recommendation, and simultaneously avoid a situation where different types of POI features are covered or suppressed with each other, the POI association feature is obtained typically by means of splicing the features.

The user implicit feature may be understood as a user additional attribute corresponding to the interaction behavior of the user to the candidate POI, and may include a user preference, an implicit relationship between the user and the POI. For example, the user often goes to the library probably because the user likes to be quiet, the user likes to read books, or other reasons. The above reasons are different from the basic attributes of the user and directly affect the user of the interaction behavior to the candidate POIs. Therefore, feature extraction needs to be performed on the historical interaction feature in a user dimension, and the extracted feature is taken as the user implicit feature to assist in the POI recommendation, thereby improving the richness of the reference content in the POI recommendation

In order to map the user association feature to a space matching the POI association feature, a user inter-hierarchy propagation feature needs to be introduced in addition to the user explicit feature and the user implicit feature when the user association feature is generated.

Exemplarily, the trained user inter-hierarchy propagation parameter may be directly obtained as the user inter-hierarchy propagation feature. The user inter-hierarchy propagation parameter is trained jointly with the POI inter-hierarchy propagation parameter employed when the POI inter-hierarchy propagation feature is extracted. For the detailed training process, please refer to following embodiments.

Exemplarily, generating the user association feature based on the user explicit feature, the user implicit feature and the user inter-hierarchy propagation feature may include: performing feature merging on the user explicit feature, the user implicit feature and the user inter-hierarchy propagation feature to obtain the POI association feature. The feature merging may be in a form of superposing or splicing the features.

In order to enable different types of user features to play a synergistic role in the POI recommendation, and simultaneously avoid a situation where different types of user features are covered or suppressed with each other, the user association feature is obtained typically by splicing the features.

Exemplarily, generating the matrix of feature recommending values based on the POI association feature and the user association feature may be implemented by processing the POI association feature and the user association feature through a matrix multiplication. The element in the matrix of feature recommending values is a predicted interest degree of the user to be recommended to each candidate POI of each hierarchy under a feature dimension, that is, the feature recommending value.

It may be understood that, the POI association feature and the user association feature are constructed respectively for determining the matrix of feature recommending values, which perfects a mechanism of determining the matrix of feature recommending values and lays a foundation for improving the accuracy of the POI recommending result. Meanwhile, the POI implicit feature and the POI inter-hierarchy propagation feature are introduced in the process of constructing the POI association feature, and the user implicit feature is introduced in the process of constructing the user association feature, which improves the richness and comprehensiveness of information carried in the POI association feature and the user association feature, and provides a guarantee for further improving the accuracy of the POI recommending result.

At block S206, at least one target POI is selected from the candidate POIs of each hierarchy for recommendation based on the matrix of feature recommending values for each hierarchy.

For the matrix of feature recommending values corresponding to each hierarchy, the at least one target POI is selected from the candidate POIs with a feature recommending value greater than a set percentage threshold for recommendation. The set percentage threshold may be determined by the skilled in the art based on an empirical value, or determined through a large number of experiments.

In embodiments of the disclosure, the matrix of recommending values is refined to include a matrix of feature recommending values. Accordingly, the operation “determining the matrix of recommending values” is refined into the operation “determining the inter-hierarchy propagation feature of the current hierarchy based on the POI explicit feature and the historical interaction feature in combination with the spatial coverage relationship between the candidate POIs at adjacent hierarchies in the POI hierarchical structure; and generating the matrix of recommending values based on the user explicit feature, the historical interaction feature and the inter-hierarchy propagation feature”. With the above technical solution, the information contained in the matrix of feature recommending values is enriched by introducing the inter-hierarchy propagation feature, and a foundation is laid for improving the accuracy of the POI recommending result. The inter-hierarchy propagation feature is determined based on the spatial coverage relationship between the candidate POIs at adjacent hierarchies in the POI hierarchy structure, thereby implementing the transmission of the POI feature between the adjacent hierarchies, and providing a guarantee for further improving the accuracy of the POI recommending result.

In order to implement the interpretability of the POI recommending result, the following operations may also be performed on the basis of the above technical solutions: obtaining a POI hierarchy propagation vector of each child POI node of the target POI in the POI inter-hierarchy propagation feature, obtaining a user hierarchy propagation vector of the user to be recommended in the user inter-hierarchy propagation feature, and determining an importance of each child POI node based on the POI hierarchy propagation vector and the user hierarchy propagation vector.

In detail, the POI hierarchical propagation vector corresponding to each child node of the target POI is obtained in the POI hierarchical propagation feature of the target POI. The user hierarchy propagation vector of the user to be recommended is obtained in the user hierarchy propagation feature of the user to be recommended. A product of the user hierarchy propagation vector and the POI hierarchy propagation vector corresponding to each child node is respectively determined, to obtain the feature preference value of the user to be recommended for each child POI node. An importance of each child POI node is determined based on a ratio of the feature preference value of each child POI node to a sum of the feature preference values of all child POI nodes.

It may be understood that, the importance of the child POI node is determined by the user-hierarchy propagation vector of the user to be recommended and the POI-hierarchy propagation vector of each child POI node, such that the importance of each child POI node is evaluated in the user feature dimension and in the POI feature dimension, and a contribution degree of all child POI nodes covered by the parent POI node is mapped out when the parent POI node is recommended.

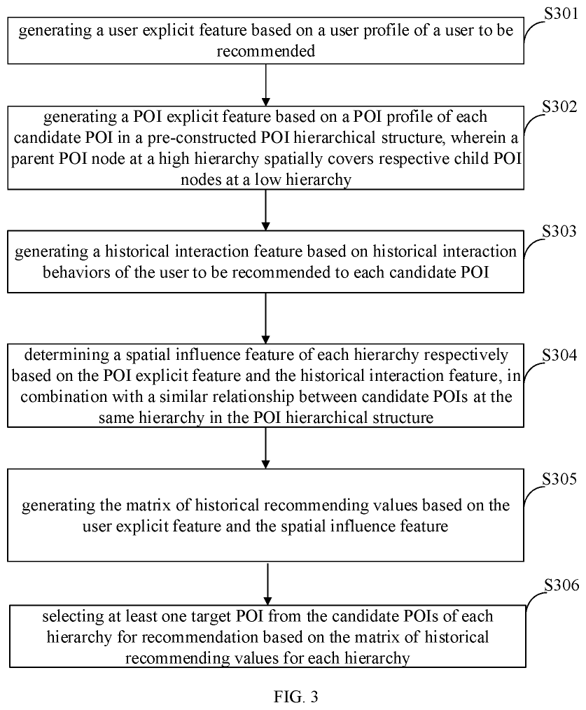

FIG. 3 is a flow chart illustrating another method for recommending a point of interest according to embodiment of the disclosure. The method is optimized and improved on the basis of the above technical solutions.

Further, the matrix of recommending values is refined to include a matrix of historical recommending values. Correspondingly, the operation “determining the matrix of recommending values for each hierarchy based on the at least one of the user explicit feature, the POI explicit feature and the historical interaction feature, in combination with the association relationship between the intra-hierarchy candidate POIs in the POI hierarchical structure” is refined to the operation “determining a spatial influence feature of each hierarchy respectively based on the POI explicit feature and the historical interaction feature, in combination with a similar relationship between candidate POIs at the same hierarchy in the POI hierarchical structure; and generating the matrix of historical recommending values based on the user explicit feature and the spatial influence feature”, to perfect the generating mode of the matrix of historical recommending values.

The method for recommending the point of interest illustrated in FIG. 3 includes the following blocks S301-S306.

At block S301, a user explicit feature is generated based on a user profile of a user to be recommended.

At block S302, a POI explicit feature is generated based on a POI profile of each candidate POI in a pre-constructed POI hierarchical structure. A parent POI node at a high hierarchy spatially covers each child POI node at a low hierarchy.

At block S303, a historical interaction feature is generated based on historical interaction behaviors of the user to be recommended to each candidate POI.

At block S304, a spatial influence feature of each hierarchy is respectively determined based on the POI explicit feature and the historical interaction feature, in combination with a similar relationship between candidate POIs at the same hierarchy in the POI hierarchical structure.

The similar relationship may include at least one of an association search relationship, an association visiting relationship and a spatial adjacent relationship. The association search relationship may be understood as that: two candidate POIs have the association search relationship when more than a first set number of users simultaneously search the two candidate POIs within a first set time period. The association visiting relationship may be understood as that: two candidate POIs have the association visiting relationship when more than a second set number of users simultaneously visit the two candidate POIs within a second set time period. The spatial adjacent relationship may be understood as that: the two candidate POIs have the spatial adjacent relationship when a spatial distance between two candidate POIs is lower than a set distance threshold. The first set number of users, the first set time period, the second set number of users, the second set time period and the set distance threshold may be determined by the skilled in the art based on a requirement or an experience value. The first set number of users may be the same as or different from the second set number of users, and the first set time period may be the same as or different from the second set time period.

It may be understood that, the implicit information associated with the POIs at the same hierarchy in the historical interaction feature is transmitted between similar POIs at the same hierarchy based on the similar relationship between the candidate POIs at the same hierarchy in the POI hierarchy structure, thereby avoiding an isolated situation of candidate POI information, and improving the richness of the reference content in the POI recommendation.

In an alternative implementation, for each of the candidate POIs at the same hierarchy in the POI hierarchical structure, a similar POI having the similar relationship with the candidate POI is determined based on the historical interaction feature. A spatial influence vector of each candidate POI is determined based on a POI explicit feature of the similar POI. The spatial influence feature of the hierarchy is generated based on the spatial influence vector of each candidate POI at the same hierarchy.

Exemplarily, a POI context map may be constructed in advance for the candidate POIs at various hierarchies. A node in the POI context map represents the candidate POI. An edge connection between the nodes in the POI context map represents the similar relationship between the candidate POIs. Accordingly, the similar POIs are determined based on the POI context map and the historical interaction feature. In detail, when there are two candidate POIs with an edge connection relationship directly or indirectly in the POI context map among the candidate POIs having the historical interaction behavior to the user to be recommended, it is determined that the two candidate POIs are the similar POIs.

In order to facilitate subsequent calculation, an edge attribute may also be added for each edge, and may be configured to quantify the similarity between the two candidate POIs connected by the edge connection. Accordingly, the spatial influence vector of the candidate POI is determined based on the POI explicit feature of each candidate POI and the similarity between the candidate POI and each similar POI. In detail, the spatial influence vector of the candidate POI is determined based on a sum of products of the similarities of respective similar POIs and the POI explicit feature.

Alternatively, the similarity between the similar POIs may include at least one of a search similarity, a visiting similarity and a spatial similarity.

Exemplarily, the search similarity corresponds to the association search relationship, and is configured to characterize a situation where the similar POIs are searched simultaneously by the user. In detail, the search similarity may be determined by the number of searching times for which the similar POIs are searched simultaneously within a first set time interval. For example, the number of searching times may be directly taken as the search similarity. Alternatively, a search frequency may be determined based on the number of searching times and a duration of the first set time interval, and the search frequency may be taken as the search similarity. The first set time interval may be determined by the skilled in the art based on an experience value, and may also be determined through a large number of experiments.

Exemplarily, the visiting similarity corresponds to the association visiting relationship, and is configured to characterize a situation where the similar POIs are visited simultaneously by the user. In detail, the visiting similarity may be determined by the number of visiting times for which the similar POIs are visited simultaneously within a second set time interval. For example, the number of visiting times may be directly taken as the visiting similarity. Alternatively, a visiting frequency may be determined based on the visiting times and a duration of the second set time interval, and the visiting frequency may be taken as the visiting similarity. The second set time interval may be determined by the skilled in the art based on an empirical value, and may also be determined through a large number of experiments. The first set time interval is the same as or different from the duration of the second set time interval.

Exemplarily, the spatial similarity corresponds to the spatial adjacent relationship, and is configured to characterize a physical spatial distance between the similar POIs. In detail, a distance between two similar POIs may be determined, and the spatial similarity between the two similar POIs may be determined based on the determined distance by employing a spatial similarity function. The distance may include a Euclidean distance or Mahalanobis distance. The spatial similarity function is a decreasing function of the distance, which may be determined by the skilled in the art based on an experience value, or determined through a large number of experiments.

It should be noted that, there is a data imbalance in the similarity determining results due to different methods for determining the similarity. In order to avoid the influence on the spatial influence vector due to the data imbalance in the similarity determining results, which further affects the accuracy of the POI recommending result, embodiments of the disclosure may also perform the normalization processing on each similarity by employing a normalization function after determining the similarity. The normalization function may include at least one of a sigmoid function, a Tan h function, a softmax function, and the like.

It may be understood that, the similar POIs of the candidate POIs are introduced, and the spatial influence vector of the candidate POIs is determined based on the explicit features of the similar POIs, thereby implementing the mapping of the similar POI features to the corresponding candidate POIs, improving the information richness of the candidate POIs and laying a foundation for further improving the accuracy of the POI recommending result.

At block S305, the matrix of historical recommending values is generated based on the user explicit feature and the spatial influence feature.

In detail, the spatial influence feature is processed by the user explicit feature of the user to be recommended, such that an interest degree of the user to be recommended to each candidate POI may be determined based on the similar relationship between the user preference and the candidate POI, that is, the historical recommending value in the matrix of historical recommending values, which may be configured as the reference for the POI recommendation.

Exemplarily, a POI preference vector is generated based on the user explicit feature and the spatial influence feature. The matrix of historical recommending values is generated based on the POI preference vector.

In detail, the user explicit feature of the user to be recommended and the spatial influence feature of the hierarchy are processed by a matrix multiplication to obtain the POI preference vector. The POI preference vector is taken as the matrix of historical recommending values of the hierarchy. The element in the POI preference vector is a predicted interest degree of the user to be recommended to each candidate POI of the hierarchy under a historical interaction dimension, that is, the historical recommending value.

It may be understood that, the POI preference vector is generated based on the user explicit feature and the spatial influence feature, thus the interest degree of the user to be recommended to each candidate POI is predicted based on the user preference and a mutual effect of the similar POIs of the candidate POI, thereby improving the accuracy of the determination result of each interest degree, and laying a foundation for improving the accuracy of the POI recommending result.

At block S306, at least one target POI is respectively selected from the candidate POIs of each hierarchy for recommendation based on the matrix of historical recommending values for each hierarchy.

For the matrix of historical recommending values corresponding to each hierarchy, the at least one target POI is selected from each candidate POI with the historical recommending value greater than a set percentage threshold for recommendation. The set percentage threshold may be determined by the skilled in the art based on an empirical value, or determined through a large number of experiments.

In embodiments of the disclosure, the matrix of recommending values is refined to include the matrix of historical recommending values. Correspondingly, the operation “determining the matrix of recommending values” is refined to “determining the spatial influence feature of each hierarchy respectively based on the POI explicit feature and the historical interaction feature, in combination with the similar relationship between the candidate POIs at the same hierarchy in the POI hierarchical structure; and generating the matrix of historical recommending values based on the user explicit feature and the spatial influence feature”. With the above technical solution, the introduction of the spatial influence feature enriches the information contained in the matrix of historical recommending values and lays a foundation for improving the accuracy of the POI recommending result. The spatial influence feature is determined based on the similar relationship between the candidate POIs at the same hierarchy in the POI hierarchy structure, and the transmission of the POI feature in the same hierarchy is realized, thereby providing a guarantee for further improving the accuracy of the POI recommending result.

In order to implement the interpretability of the POI recommending result, the following operations may also be performed on the basis of the above technical solutions: obtaining a preference value of each historical interaction POI in the POI preference vector, and determining a spatial influence of the target POI based on a ratio of a preference value of the target POI to a sum of the preference values of historical interaction POIs.

It may be understood that, the spatial influence of the target POI may be determined based on the POI preference vector determined by the user explicit feature and the spatial influence feature. The influences of the historical interaction POIs on the recommending result of the target POI may be quantified, thereby explaining the selection of the target POI in the historical interaction dimension.

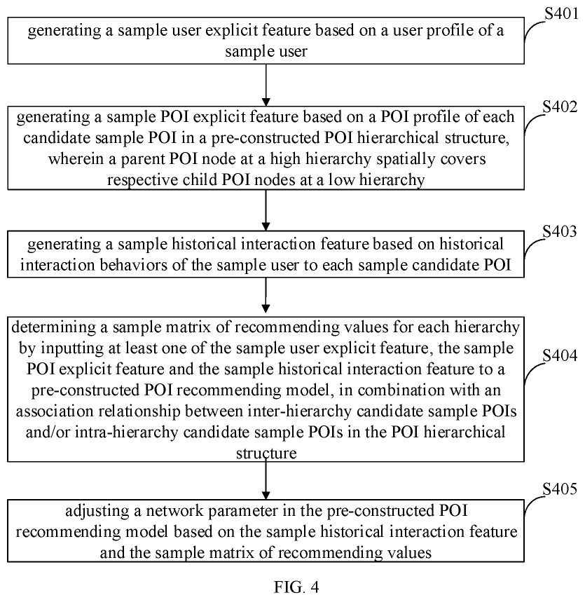

FIG. 4 is a flow chart illustrating another method for recommending a point of interest according to embodiment of the disclosure. The method is executed by a training device for performing model training on the POI recommending model based on artificial intelligence technologies. The training device may be the same as or different from the electronic device employed in the above method for recommending the POI.

The method for recommending the point of interest illustrated in FIG. 4 includes the following blocks S401-S405.

At block S401, a sample user explicit feature is generated based on a user profile of a sample user.

At block S402, a sample POI explicit feature is generated based on a POI profile of each candidate sample POI in a pre-constructed POI hierarchical structure. A parent POI node space at a high hierarchy spatially covers each child node POI at a low hierarchy.

At block S403, a sample historical interaction feature is generated based on historical interaction behaviors of the sample user to each candidate sample POI.

At block S404, a sample matrix of recommending values for each hierarchy is determined by inputting at least one of the sample user explicit feature, the sample POI explicit feature and the sample historical interaction feature to a pre-constructed POI recommending model, in combination with an association relationship between inter-hierarchy candidate sample POIs and/or intra-hierarchy candidate sample POIs in the POI hierarchical structure.

Alternatively, the POI recommending model includes a feature recommending hierarchy and/or a historical recommending hierarchy.

In an alternative implementation, the feature recommending hierarchy is configured to determine a sample inter-hierarchy propagation feature of the current hierarchy based on the at least one of the sample user explicit feature, the sample POI explicit feature and the sample historical interaction feature, in combination with a spatial coverage relationship between the candidate sample POIs at adjacent hierarchies in the POI hierarchical structure, and to generate the sample matrix of recommending values based on the sample user explicit feature, the sample historical interaction feature and the sample inter-hierarchy propagation feature.

Exemplarily, the feature recommending hierarchy includes a user association feature determining module, a POI association feature determining module and a feature recommending matrix determining module.

The POI association feature determining module is configured to generate a sample POI implicit feature based on the sample historical interaction feature and a POI implicit parameter to be trained; to generate a sample POI inter-hierarchy propagation feature of the parent POI node based on the sample POI implicit feature of the child POI node in the POI hierarchy structure and a POI inter-hierarchy propagation parameter to be trained; and to perform feature merging on the sample POI explicit feature, the sample POI implicit feature and the sample POI inter-hierarchy propagation feature to obtain a sample POI association feature.

The user association feature determining module is configured to generate a sample user implicit feature based on the sample historical interaction feature and a user implicit parameter to be trained; and to perform feature merging on the sample user explicit feature, the sample user implicit feature and the sample user inter-hierarchy propagation feature to be trained (i.e., a sample user inter-hierarchy propagation parameter to be trained) to obtain a sample user association feature.

The feature recommending matrix determining module is configured to calculate the sample POI association feature of each candidate sample POI and the sample user association feature of each sample user by a matrix multiplication to obtain a sample matrix of feature recommending values. The sample matrix of feature recommending values contains a feature recommending value predicted when the POI recommendation of each candidate sample is performed for each sample user.

In an alternative implementation, the historical recommending hierarchy is configured to determine a sample spatial influence feature of each hierarchy based on the sample POI explicit feature and the sample historical interaction feature, in combination with the similar relationship between the candidate sample POIs at the same hierarchy in the POI hierarchy structure, and to generate a sample matrix of historical recommending values based on the sample user explicit feature and the sample spatial influence feature.

Exemplarily, the historical recommending hierarchy includes a spatial influence matrix determining module, a POI preference matrix determining module and a historical recommending matrix determining module.

The spatial influence matrix determining module is configured to, for each of the candidate POIs at the same hierarchy in the POI hierarchical structure, determine a similar POI having the similar relationship with the candidate sample POI based on the sample historical interaction feature; to determine a sample spatial influence vector of each candidate sample POI based on a sample POI explicit feature of the similar POI and a similarity determining parameter to be trained; and to generate a sample spatial influence feature of the hierarchy based on the sample spatial influence vector of each candidate sample POI at the same hierarchy.

The POI preference matrix determining module is configured to generate a sample POI preference vector based on the sample user explicit feature and the sample spatial influence feature.

The historical recommending matrix determining module is configured to generate the sample matrix of historical recommending values based on a sample POI preference vector of each sample user.

At block S405, a network parameter in the POI recommending model is adjusted based on the sample historical interaction feature and the sample matrix of recommending values.

The network parameter may include at least one of the above POI implicit parameter, the POI inter-hierarchy propagation parameter, the user implicit parameter, the user inter-hierarchy propagation parameter and the similarity determining parameter.

Alternatively, based on the sample historical interaction feature, an actual interaction of each sample user to each candidate sample POI is determined, and an interaction tag value for the actual interaction of each sample user to each candidate sample POI is also determined. Based on the predicted recommending value in the sample matrix of recommending values and the interaction tag value of each sample user to each candidate sample POI, the network parameter in the POI recommending model is adjusted until an adjustment termination condition is met.

It may be understood that, the POI recommending model is supervised and trained by introducing the interaction tag value, such that the predicted recommending value determined by the POI recommending model is gradually close to the interaction tag value, thereby enabling the POI recommending model to have the POI recommendation capability and ensuring the accuracy of the recommending result of the POI recommending model.

Alternatively, a positive candidate sample POI and a negative candidate sample POI of the sample user are determined based on the sample historical interaction feature. The network parameter in the POI recommending model is adjusted based on a predicted difference between the predicted recommending value of the positive candidate sample POI and the predicted recommending value of the negative candidate sample POI in the sample matrix of recommending values, until the adjustment termination condition is met.

It may be understood that, by introducing the predicted difference between the predicted recommending value of the positive candidate sample POI and the predicted recommending value of the negative candidate sample POI, the parameter adjustment process of the POI recommending model is guided. Therefore, by maximizing the predicted recommending values of positive and negative samples, two matching degrees are considered at the same time, i.e., the matching degree between the predicted recommending value of the positive candidate sample POI and the actual interaction situation as well as the matching degree between the predicted recommending value of the negative candidate sample POI and the actual interaction situation, thereby improving the sensitivity and specificity of the POI recommending model and further improving the accuracy of the POI recommending result.

The adjustment termination condition may include at least one of: the number of training samples reaching a set sample size threshold, the number of training times reaching a set number threshold, and a function value of a constructed target loss function tending to be stable. The target loss function may employ at least one loss function in the related art. For example, the target loss function may be a cross entropy loss function.

In embodiments of the disclosure, by introducing the POI hierarchical structure and combining with the association relationship between the inter-hierarchy candidate sample POIs and/or the intra-hierarchy candidate POIs in the POI hierarchical structure when the POI recommending model is trained, a sparsity problem caused by information isolation when the POI recommending model is trained for a single hierarchy is avoided, thereby improving the accuracy of the recommending result of the POI recommending model. Meanwhile, during training the POI recommending model, mixed training for multi-hierarchy POIs is performed, without building a recommending model for single-hierarchy POIs, such that the POI recommending model has the comprehensive recommendation ability for the multi-hierarchy POIs.

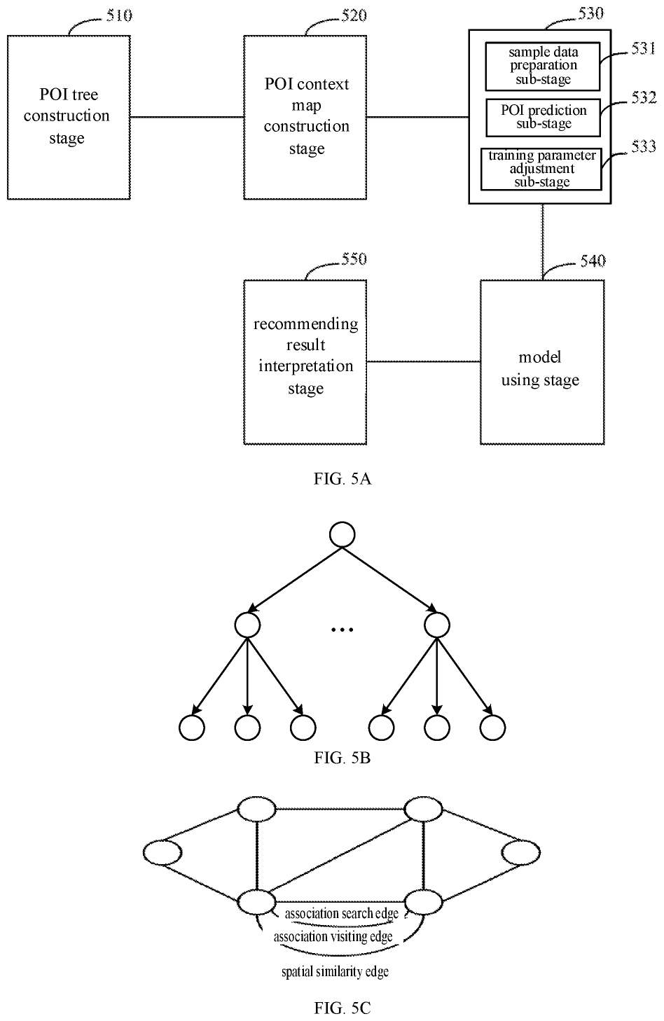

FIG. 5A is a flow chart illustrating another method for recommending a point of interest according to embodiment of the disclosure. The method provides a preferred embodiment on the basis of the above technical solution.

The method for recommending the point of interest illustrated in FIG. 5A includes: a POI tree construction stage 510, a POI context map construction stage 520, a model training stage 530, a model using stage 540 and a recommending result interpretation stage 550.

Exemplarily, the POI tree construction stage 510 includes: constructing a POI tree based on a physical spatial coverage relationship between respective candidate POIs.

Referring to a structural schematic diagram of a POI tree illustrated in FIG. 5B, the POI tree is a tree data structure with L hierarchies, and each node represents a candidate POI. For the convenience of subsequent description, Hₗ represents a tree with L hierarchies, and nₗ represents the number of POIs at the L-th hierarchy of the POI tree. If a node pᵢ^{l+1} is covered by a node pᵢ^{l} in the physical space, the node pᵢ^{l} is a parent node of the node pᵢ^{l+1} and the node pᵢ^{l+1} is a child node of the node pᵢ^{l}. For the convenience of subsequent description, all child nodes of the node pᵢ^{l} are represented by C(pᵢ^{l}).

Exemplarily, the POI context map construction stage 520 includes: constructing the POI context map for respective candidate POIs at each hierarchy of the POI tree based on the similarity between the candidate POIs.

Referring to a structural schematic diagram of a POI context map illustrated in FIG. 5C, each node represents each candidate POI in the POI hierarchical tree, and an edge connection between the nodes represents that two connected candidate POIs directly have a similar relationship. To facilitate subsequent description, the POI context map may be expressed as ζ=(ν,ε), where ν represents a set of POIs in the POI hierarchical tree, and c represents the set of edges between the two candidate POIs.

For any two POIs (p₁ and p₂), the edge may be defined based on the similarity between POIs. Exemplarily, the edge may be defined in at least one of following ways.

1) An association search edge: when multiple users simultaneously search the p₁ and p₂ within the first set time interval, it may be determined that there is the association search relationship between the p₁ and p₂, and an association search edge connection is established between the p₁ and p₂. Meanwhile, the search similarity determined based on the common searching times within a time interval [symbol] t₁ is represented by δ(p₁,p₂ [symbol] t₁). The parameter to be trained is contained in the δ(p₁,p₂ [symbol] t₁). The first time interval is an empirical value, such as 30 minutes.

2) An association visiting edge: when multiple users simultaneously visit the p₁ and p₂ within the second set time interval, it may be determined that there is the association visiting relationship between the p₁ and p₂, and an association visiting edge connection is established between the p₁ and p₂. Meanwhile, the visiting similarity determined based on common visiting times within a time interval □t₂ is represented by ψ(p₁, p₂ [symbol] t₂). The parameter to be trained is contained in the ψ(p₁,p₂ [symbol] t₂). The second set time interval is an empirical value, such as 30 minutes.

3) A spatial similarity edge: when a spatial distance between the p₁ and p₂ is lower than a set distance threshold, it may be determined that there is the spatial similarity relationship between the p₁ and p₂, and a spatial similarity edge connection is established between the p₁ and p₂. Meanwhile, the spatial similarity determined based on a distance between the p₁ and p₂ is identified by ξ(p₁,p₂). The distance between the p₁ and p₂ may be a Euclidean distance. The parameter to be trained is contained in ξ(p₁,p₂). The distance threshold is set as an empirical value, such as 1000 meters.

In order to avoid respective similarity determining results unbalanced, a normalization function may also be employed to perform the normalization processing on different similarities. Exemplarily, the normalization function may be σ(x)=1/(1+e^{-x}), where x represents a search similarity, an visiting similarity or a spatial similarity.

Exemplarily, the model training stage 530 includes: a sample data preparation sub-stage 531, a POI prediction sub-stage 532 and a training parameter adjustment sub-stage 533.

Exemplarily, the sample data preparation sub-stage 531 includes: encoding a user profile of each sample user to obtain a structured sample user explicit feature; encoding the POI profile of each candidate POI to obtain a structured sample POI explicit feature; and constructing a sample historical interaction feature of the sample user based on a historical interaction of the sample user to each candidate POI. The interaction may be visiting or searching.

In order to clearly introduce the process of performing the POI recommendation and prediction on sample data in the POI prediction sub-stage 532, the POI recommending model is described in detail firstly.

Referring to a structural schematic diagram of a POI recommending model illustrated in FIG. 5D, the POI recommending model includes a feature recommending hierarchy and a historical recommending hierarchy. The feature recommending hierarchy includes a user association feature determining module, a POI association feature determining module and a feature recommendation matrix determining module. The historical recommendation hierarchy includes a spatial influence matrix determining module, a POI preference matrix determining module and a historical recommendation matrix determining module.

Exemplarily, the user association feature determining module is configured to generate a sample user implicit feature based on the historical interaction feature and a user implicit parameter to be trained; and to splice and merge the sample user explicit feature, the sample user implicit feature and the sample user inter-hierarchy propagation feature to obtain a sample user association feature. The sample user inter-hierarchy propagation feature is the sample user inter-hierarchy propagation parameter to be trained.

In detail, the sample user association feature may be generated based on:

P^{l}=Uᵤ⊕Hᵤ^{l}⊕Aᵤ^{l},

where, P^{l}∈ [symbol] ^{m×(r+r}^{ₗ}^{+r}^{ₗ₊₁}⁾ represents a sample user association feature corresponding to the l-th hierarchy in the POI tree; m represents the number of sample users; r represents a size of the explicit feature in the sample user explicit feature Uᵤ∈ [symbol] ^{m×r}; rₗ represents a size of the implicit feature in the sample user implicit feature Hᵤ^{l}∈ [symbol] ^{m×r}^{ₗ}; rₗ₊₁ represents a size of the propagation feature in the sample user inter-hierarchy propagation feature Aᵤ^{l}∈ [symbol] ^{m×r}^{ₗ₊₁}; and ⊕ represents a matrix splicing operation.

Exemplarily, the POI association feature determining module is configured to: generate a sample POI implicit feature based on the sample historical interaction feature and the POI implicit parameter to be trained; generate the sample POI inter-hierarchy propagation feature of the parent POI node based on the sample POI implicit feature of the child POI node in the POI hierarchy structure and the POI inter-hierarchy propagation parameter to be trained; and perform feature merging on the sample POI explicit feature, the sample POI implicit feature and the sample POI inter-hierarchy propagation feature to obtain a sample POI association feature.

In detail, the sample POI association feature is generated based on:

Q^{l}=Uₚ^{l}⊕Hₚ^{l}⊕Aₚ^{l},

where, Q^{l}∈ [symbol] ⁿ^{ₗ}^{×(r+r}^{ₗ}^{+r}^{ₗ₊₁}⁾ represents a sample POI association feature corresponding to the l-th hierarchy in the POI tree; nₗ represents the number of candidate sample POIs in the l-th hierarchy in the POI tree; r represents a size of the explicit feature in the sample POI explicit feature Uₚ^{l}∈ [symbol] ⁿ^{ₗ}^{×r}; rₗ is a size of the implicit feature in the sample POI implicit feature Hₚ^{l}∈ [symbol] ⁿ^{ₗ}^{×r}^{ₗ}; rₗ₊₁ represents a size of the propagation feature in the sample POI inter-hierarchy propagation feature Aₚ^{l}∈ [symbol] ⁿ^{ₗ}^{×r}^{ₗ₊₁}; and ⊕ represents a matrix splicing operation.

Exemplarily, the sample POI inter-hierarchy propagation feature is configured to characterize feature information propagated from the child POI node to the parent POI node in the POI tree. In the POI tree, for each parent POI node pᵢ^{l}, the POI representation propagated from all child POI nodes pⱼ^{l+1} of the parent POI node may also be learned. In other word, for all child nodes pⱼ^{l+1} of the parent POI node pⱼ^{l+1} the propagation feature vector aᵢ^{l} of the parent POI node pᵢ^{l} may be constructed based on the POI implicit feature vector hⱼ^{l+1}∈Hₚ^{l+1} of each child node pⱼ^{l+1}. aᵢ^{l} represents a vector corresponding to the parent POI node pᵢ^{l} in the matrix Aₚ^{l}∈ [symbol] ⁿ^{ₗ}^{×r}^{_{l×1}} of sample POI inter-hierarchy propagation features.

In detail, weights of different child POI nodes may be learned through the following attention learning mechanism, and the propagation feature vector is then determined:

$$\{ \begin{matrix}{w}_{j}^{l + 1} = F ( {h}_{j}^{l + 1} ) = d ReLU ( {W}^{l + 1} {h}_{j}^{l + 1} + {b}_{1} ) + {b}_{2} \\ {\tilde{w}}_{j}^{l + 1} = σ ( {w}_{j}^{l + 1} ) = \frac{exp ( {w}_{j}^{l + 1} )}{{Σ}_{{p}_{t}^{l + 1} ∈ C ( {p}_{i}^{l} )} exp ( {w}_{t}^{l + 1} )} \\ {a}_{i}^{l} = {Σ}_{{p}_{j}^{l + 1} ∈ C ( {p}_{i}^{l} )} {\tilde{w}}_{j}^{l + 1} {h}_{j}^{l + 1} \end{matrix} ,$$

where, ReLU(x)=max(0, x) represents an activate function, wⱼ^{l+1} represents an attention weight of the child node pⱼ^{l+1}, \tilde{w}ⱼ^{l+1} represents an attention weight after performing the normalization processing on wⱼ^{l+1} by a softmax function, and d, b₁, b₂ and W^{l+1} represent the parameters to be trained.

Exemplarily, the feature recommendation matrix determining module is configured to calculate the sample POI association feature of each candidate sample POI and the sample user association features of each sample user by a matrix multiplication to obtain a sample matrix of feature recommending values. The sample matrix of feature recommending values includes the predicted feature recommending value when the POI recommendation for each candidate sample is performed for each sample user.

In detail, the sample matrix of feature recommending values is generated based on:

S^{l}=P^{l}(Q^{l})^{T},

where, S^{l}∈ [symbol] ^{m×n}^{ₗ} represents the sample matrix of feature recommending values corresponding to the l-th hierarchy in the POI tree.

Exemplarily, the spatial influence matrix determining module is configured to, for each of the candidate POIs at the same hierarchy in the POI hierarchical structure, determine a similar POI having the similar relationship with the candidate sample POI based on the sample historical interaction feature; to determine a sample spatial influence vector of each candidate sample POI based on a sample POI explicit feature of the similar POI and a similarity determining parameter to be trained; to generate a sample spatial influence feature of the hierarchy based on the sample space influence vector of each candidate sample POI at the same hierarchy.

In detail, the sample spatial influence feature U_{g,u}_{ₖ}^{l}∈ [symbol] ⁿ^{ₗ}^{×r} may be introduced, and the set of POIs Q_{S}^{u}^{ₖ} visited by the sample user uₖ may be determined based on the sample historical interaction feature (the size of Q_{S}^{u}^{ₖ} represents t, i.e, |Q_{S}^{u}^{ₖ}|=t).

In detail, the sample spatial influence feature is determined based on:

$${μ}_{g , {u}_{k}}^{l , {p}_{i}} = \frac{1}{t} {Σ}_{{p}_{j} ∈ {Q}_{S}^{{u}_{k}}} δ ( {p}_{i} , {p}_{j} \vert ‖ {t}_{1} ) ψ ( {p}_{i} , {p}_{j} \vert ‖ {t}_{2} ) ζ ( {p}_{i} , {p}_{j} ) {v}_{{p}_{j}}^{l} ,$$

where, μ_{g,u}_{ₖ}^{l,p}^{ᵢ}∈U_{g,u}_{ₖ}^{l} represents the sample space influence vector of each sample user uₖ to each POI in the l-th hierarchy of the POI tree; and vₚ_{ⱼ}^{l}∈Uₚ^{l} represents the feature representation of the POI pⱼ in the sample explicit feature Uₚ^{l}.

Exemplarily, the POI preference matrix determining module is configured to generate a sample POI preference vector based on the sample user explicit feature and the spatial influence feature.

In detail, the sample POI preference vector is generated by:

gᵤ_{ₖ}^{l}=υₖ(U_{g,u}_{ₖ}^{l})^{T},

where, gᵤ_{ₖ}^{l} represents the sample POI preference vector for each POI in the l-th hierarchy of the POI tree; and υₖ∈Uᵤ represents the feature representation of the sample user uₖ in the sample user explicit feature Uᵤ.

Exemplarily, the historical recommendation matrix determining module is configured to generate a sample matrix of historical recommending values based on the sample POI preference vector of each sample user.

In detail, the sample matrix of historical recommending values may be generated by:

G^{l}=[ . . . ,(gᵤ_{ₖ}^{l})^{T}, . . . ]^{T},

where, G^{l}∈ [symbol] ^{m×n}^{ₗ} represents the sample matrix of historical recommending values corresponding to the l-th hierarchy of the POI tree of each sample user.

Exemplarily, the training parameter adjustment sub-stage 533 includes: determining a sample matrix of target recommending values based on the sample matrix of feature recommending values and the sample matrix of historical recommending values; constructing a target loss function based on the sample matrix of target recommending values, and adjusting a network parameter in the POI recommending model based on the function value of the target loss function.

In detail, the sample matrix of target recommending values may be determined by:

O^{l}=S^{l}+τG^{l},

where, O^{l} represents the sample matrix of target recommending values corresponding to the l-th hierarchy of the POI tree; S^{l} represents the sample matrix of feature recommending values corresponding to the l-th hierarchy of the POI tree; G^{l} represents the sample matrix of historical recommending values corresponding to the l-th hierarchy of the POI tree; and τ represents a weight parameter, which may be set as an empirical value, such as 0.5.

In detail, the target loss function may be constructed by:

$${L}_{2} = - {\sum }_{l = 1}^{L} {\sum }_{i = 1}^{m} {\sum }_{j = 1}^{{n}_{l}} ln σ ( {O}_{i , {p}_{j}^{+}}^{l} , {O}_{i , {p}_{j}^{-}}^{l} ) ,$$

where, pⱼ⁺ represents a positive sample POI visited by the sample user; pⱼ⁻ represents a negative sample POI which the sample user does not visit; O_{i,p}_{ⱼ}_{⁺}^{l} represents the sample matrix of target recommending values corresponding to the i-th sample user in the l-th hierarchy of the POI tree relative to the positive sample POI pⱼ⁺; O_{i,p}_{ⱼ}_{⁺}^{l} represents the sample matrix of target recommending values corresponding to the i-th sample user in the l-th hierarchy of the POI tree relative to the negative sample POI pⱼ⁻.

Accordingly, respective network parameters in the POI recommending model are optimized and adjusted based on the function value of the target loss function L₂ to minimize the loss function or stabilize the function value of the target loss function.

Exemplarily, the model use stage 540 includes: generating the user explicit feature based on the user profile of the user to be recommended; generating the POI explicit feature based on the POI profile of each candidate POI in the POI hierarchical tree; generating the historical interaction feature based on the historical interaction behavior of the user to be recommended to each candidate POI; inputting the user explicit feature, the POI explicit feature and the historical interaction feature into the trained POI recommending model to obtain the matrix of target recommending values corresponding to each hierarchy of the POI tree; and selecting the at least one target POI from the candidate POIs of each hierarchy for recommendation based on the matrix of target recommendation values.

Exemplarily, the recommending result interpretation stage 550 is configured to provide a function of interpreting the target POI. The interpretability includes a POI interpretability, which is configured to characterize which child POI node under the parent POI node is attractive to the user to be recommended when the parent POI node is recommended. The interpretability may also include an interaction interpretability, which is configured to characterize when a new POI is recommended, which POI visited historically by the user to be recommended is related to the recommended POI.

In detail, an importance of the child POI node may be determined to characterize the POI interpretability by:

$${γ}_{1}^{{p}_{j}} = \frac{{a}_{{u}_{i}} • {a}_{{p}_{j}}}{{Σ}_{{p}_{c} ∈ C ( {p}_{j} )} {a}_{{u}_{i}} ⊐ {a}_{{p}_{c}}} ,$$

where, γ₁^{p}^{ⱼ} represents the importance of child POI node pⱼ; aᵤ_{ᵢ} represents an embedded feature vector corresponding to the user uᵢ to be recommended in Aᵤ^{l}; aₚ_{ⱼ} and aₚ_{_{c}} represent two embedded feature vectors of child POI nodes pⱼ and p_{c} in Aₚ^{l}, and [symbol] represents a dot product operation.

In detail, a spatial influence proportion of the POI visited historically may be determined to characterize the interaction interpretability by:

$${γ}_{2}^{{p}_{i}} = \frac{{g}_{{u}_{k} , {p}_{i}}^{l}}{{Σ}_{{p}_{c} ∈ {Q}_{s}^{{u}_{k}}} {g}_{{u}_{k} , {p}_{c}}^{l}} ,$$

where, γ₂^{p}^{ᵢ} represents the spatial influence proportion of the POI visited historically; and gᵤ_{ₖ}_{,p}_{ᵢ}^{l} and gᵤ_{ₖ}_{,p}_{_{c}}^{l} represent a preference value in the POI preference vector corresponding to the POIs pᵢ and p_{c} visited historically.

It should be noted that, the spatial influence proportion may be set in advance. When the determined spatial influence proportion of the POI visited historically is greater than a spatial influence proportion threshold, the POI visited historically may be regarded as the POI that affects the POI recommending result, and the corresponding spatial influence proportion may be also displayed.

In embodiments of the disclosure, by establishing the POI tree and training the POI recommending model based on a hierarchical relationship among POIs in the POI tree, when a POI (e.g. business district) at an upper hierarchy is recommended for the user, features of all child POI nodes (e.g. restaurants under the business district) under the POI may be considered comprehensively comparing with the way of establishing the POI recommending model for each hierarchy separately, thereby improving the accuracy and comprehensiveness of the POI recommending result.

In addition, the model also provides the interpretable ability of the POI recommendation. When a parent POI node is recommended, the model may give out the child POI node under said parent POI node that attracts the user to visit the parent POI node; or when a POI is recommended, the model may give out the POI visited historically by the user that has influence on this recommendation, thereby improving the user experience.

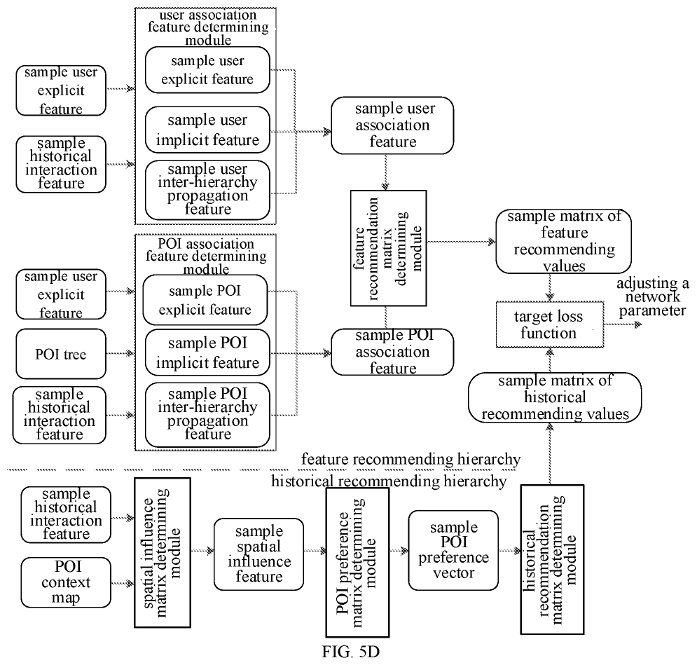

FIG. 6 is a block diagram illustrating an apparatus for recommending a point of interest according to embodiments of the disclosure. The apparatus 600 is configured in a device for recommending a point of interest. The apparatus includes: a first generating module 601, a second generating module 602, a third generating module 603, a first determining module 604, and a recommending module 605.

The first generating module 601 is configured to generate a user explicit feature based on a user profile of a user to be recommended. The second generating module 602 is configured to generate a POI explicit feature based on a POI profile of each candidate POI in a pre-constructed POI hierarchical structure. A parent POI node space at a high hierarchy spatially covers each child POI node at a low hierarchy. The third generating module 603 is configured to generate a historical interaction feature based on historical interaction behaviors of the user to be recommended to each candidate POI. The first determining module 604 is configured to determine a matrix of recommending values for each hierarchy based on at least one of the user explicit feature, the POI explicit feature and the historical interaction feature, in combination with an association relationship between inter-hierarchy candidate POIs and/or intra-hierarchy candidate POIs in the POI hierarchical structure. The recommending module 605 is configured to select at least one target POI from the candidate POIs of each hierarchy for recommendation based on the matrix of recommending values for each hierarchy.

In embodiments of the disclosure, by introducing the POI hierarchical structure and combining the association relationship between the inter-hierarchy candidate POIs and/or intra-hierarchy candidate POIs in the POI hierarchical structure, a sparsity problem caused by information isolation during the POI recommendation for a single hierarchy is avoided, further thereby improving accuracy of a POI recommending result. Meanwhile, when the POI recommendation is performed, mixed recommending for multi-hierarchy POIs is performed, without building a recommending model for single-hierarchy POIs, thereby improving the comprehensiveness and hierarchy of the POI recommending result.

Further, the matrix of recommending values includes a matrix of feature recommending values.

The first determining module 604 includes: a first determining unit, and a first generating unit. The first determining unit is configured to determine an inter-hierarchy propagation feature of a current hierarchy based on the POI explicit feature and the historical interaction feature, in combination with a spatial coverage relationship between candidate POIs at adjacent hierarchies in the POI hierarchical structure. The first generating unit is configured to generate the matrix of feature recommending values based on the user explicit feature, the historical interaction feature and the inter-hierarchy propagation feature.

Further, the inter-hierarchy propagation feature includes a POI inter-hierarchy propagation feature.

The first determining unit includes: a first generating subunit, and a second generating subunit. The first generating subunit is configured to generate a POI implicit feature based on the historical interaction feature. The second generating subunit is configured to generate a POI inter-hierarchy propagation feature of the parent POI node based on a POI implicit feature of each child POI node in the POI hierarchical structure.

Further, the first generating unit includes: a third generating subunit, a fourth generating subunit, a fifth generating subunit, and a sixth generating subunit. The third generating subunit is configured to generate a POI association feature based on the POI explicit feature, the POI implicit feature and the POI inter-hierarchy propagation feature. The fourth generating subunit is configured to generate a user implicit feature based on the historical interaction feature. The fifth generating subunit is configured to generate a user association feature based on the user explicit feature, the user implicit feature and a user inter-hierarchy propagation feature. The sixth generating subunit is configured to generate the matrix of feature recommending values based on the POI association feature and the user association feature.

Further, the second generating subunit includes: a first determining slave unit, and a second determining slave unit. The first determining slave unit is configured to determine a propagation weight of each child POI node based on the POI implicit feature of the child POI node associated with the parent POI node in the POI hierarchical structure. The second determining slave unit is configured to determine the POI inter-hierarchy propagation feature of the parent POI node based on the propagation weight and the POI implicit feature of each child POI node.

Further, the matrix of recommending values includes a matrix of historical recommending values. The first determining module 604 includes: a second determining unit, and a second generating unit. The second determining unit is configured to determine a spatial influence feature of each hierarchy respectively based on the POI explicit feature and the historical interaction feature, in combination with a similar relationship between candidate POIs with the same hierarchy in POI hierarchical structure. The second generating unit is configured to generate the matrix of historical recommending values based on the user explicit feature and the spatial influence feature.

Further, the second determining unit includes: a first determining subunit, a second determining subunit, and a seventh generating subunit. The first determining subunit is configured to, for each of the candidate POIs with the same hierarchy in the POI hierarchical structure, determine a similar POI having the similar relationship with the candidate POI based on the historical interaction feature. The second determining subunit is configured to determine a spatial influence vector of each candidate POI based on a POI explicit feature of the similar POI. The seventh generating subunit is configured to generate the spatial influence feature of the hierarchy based on the spatial influence vector of each candidate POI with the same hierarchy.

Further, the second generating unit includes: an eighth generating subunit, and a ninth generating subunit. The eighth generating subunit is configured to generate a POI preference vector based on the user explicit feature and the spatial influence feature. The ninth generating subunit is configured to generate the matrix of historical recommending values based on the POI preference vector.

Further, the similar relationship includes at least one of an associated search relationship, an associated visiting relationship and a spatial adjacent relationship.

Further, the apparatus also includes: a first obtaining module, a second obtaining module, and a second determining module. The first obtaining module is configured to obtain a POI hierarchy propagation vector of each child POI node of the target POI in the POI inter-hierarchy propagation feature. The second obtaining module is configured to obtain a user hierarchy propagation vector of the user to be recommended in the user inter-hierarchy propagation feature. The second determining module is configured to determine an importance of each child POI node based on the POI hierarchy propagation vector and the user hierarchy propagation vector.

Further, the apparatus also includes: a third obtaining module, and a third determining module. The third obtaining module is configured to obtain a preference value of each historical interaction POI in the POI preference vector. The third determining module is configured to determine a spatial influence of the target POI based on a ratio of a preference value of the target POI to a sum of the preference values of respective historical interaction POIs.

The above apparatus for recommending the point of interest may execute the method for recommending the point of interest according to any of embodiments of the disclosure, and have corresponding beneficial effects and functional modules of executing the method for recommending the point of interest.

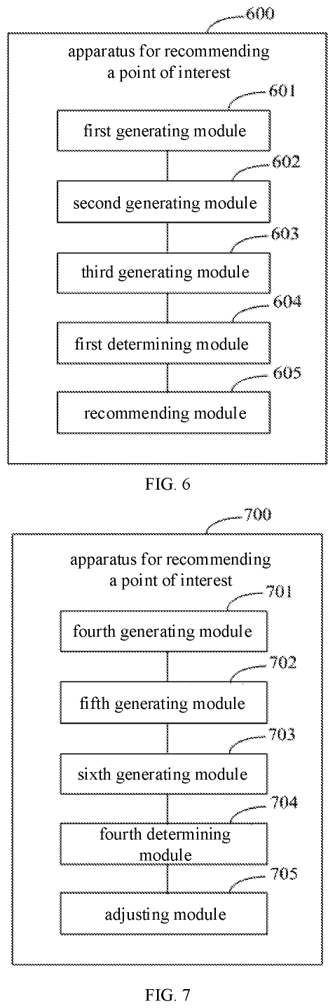

FIG. 7 is a block diagram illustrating an apparatus for recommending a point of interest according to another embodiment of the disclosure. The apparatus 700 for recommending the point of interest is configured in a training device for training a POI recommending model. The apparatus includes: a fourth generating module 701, a fifth generating module 702, a sixth generating module 703, a fourth determining module 704, and an adjusting module 705.

The fourth generating module 701 is configured to generate a sample user explicit feature based on a user profile of a sample user. The fifth generating module 702 is configured to generate a sample POI explicit feature based on a POI profile of each candidate sample POI in a pre-constructed POI hierarchical structure. A parent POI node space at a high hierarchy spatially covers each child node POI at a low hierarchy. The sixth generating module 703 is configured to generate a sample historical interaction feature based on historical interaction behaviors of the sample user to each candidate sample POI. The fourth determining module 704 is configured to determine a sample matrix of recommending values of each hierarchy by inputting at least one of the sample user explicit feature, the sample POI explicit feature and the sample historical interaction feature to a pre-constructed POI recommending model, in combination with an association relationship between inter-hierarchy candidate sample POIs and/or intra-hierarchy candidate sample POIs in the POI hierarchical structure. The adjusting module 705 is configured to adjust a network parameter in the POI recommending model based on the sample historical interaction feature and the sample matrix of recommending values.

With embodiments of the disclosure, by introducing the POI hierarchical structure and combining the association relationship between the inter-hierarchy candidate POIs and/or the intra-hierarchy candidate POIs in the POI hierarchical structure, a sparsity problem caused by information isolation during the POI recommendation for a single hierarchy is avoided, thereby improving accuracy of a POI recommending result. Meanwhile, during training the POI recommending model, mixed training for multi-hierarchy POIs is performed, without building the recommending model for a single-hierarchy POIs, such that the POI recommending model has the comprehensive recommendation ability of the multi-hierarchy POIs.

The adjusting module 705 includes: a third determining unit, and an adjusting unit. The third determining unit is configured to determine a positive candidate sample POI and a sample negative candidate POI of the sample user based on the sample historical interaction feature. The adjusting unit is configured to adjust the network parameter in the POI recommending model based on a predicted difference between a predicted recommending value of the positive candidate sample POI and a predicted recommending value of the negative candidate sample POI in the sample matrix of recommending values.

The above apparatus for recommending the point of interest may execute the method for recommending the point of interest according to any of embodiments of the disclosure, and have corresponding beneficial effects and functional modules of executing the method for recommending the point of interest.

According to embodiments of the disclosure, the disclosure also provides an electronic device and a readable storage medium. The electronic device may be a recommending device for performing POI recommendation, and a training device for performing training on a POI model.

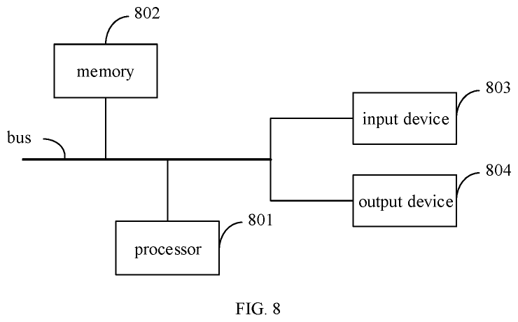

As illustrated in FIG. 8, FIG. 8 is a block diagram illustrating an electronic device capable of implementing a method for recommending a point of interest according to embodiments of the disclosure. The electronic device aims to represent various forms of digital computers, such as a laptop computer, a desktop computer, a workstation, a personal digital assistant, a server, a blade server, a mainframe computer and other suitable computer. The electronic device may also represent various forms of mobile devices, such as personal digital processing, a cellular phone, a smart phone, a wearable device and other similar computing device. The components, connections and relationships of the components, and functions of the components illustrated herein are merely examples, and are not intended to limit the implementation of the disclosure described and/or claimed herein.

As illustrated in FIG. 8, the electronic device includes: one or more processors 801, a memory 802, and interfaces for connecting various components, including a high-speed interface and a low-speed interface. Various components are connected to each other via different buses, and may be mounted on a common main board or in other ways as required. The processor may process instructions executed within the electronic device, including instructions stored in or on the memory to display graphical information of the GUI (graphical user interface) on an external input/output device (such as a display device coupled to an interface). In other implementations, multiple processors and/or multiple buses may be used together with multiple memories if desired. Similarly, multiple electronic devices may be connected, and each device provides some necessary operations (for example, as a server array, a group of blade servers, or a multiprocessor system). In FIG. 8, a processor 801 is taken as an example.

The memory 802 is a non-transitory computer readable storage medium provided by the disclosure. The memory is configured to store instructions executable by at least one processor, to enable the at least one processor to execute the method for recommending the point of interest provided by the disclosure. The non-transitory computer readable storage medium provided by the disclosure is configured to store computer instructions. The computer instructions are configured to enable a computer to execute the method for recommending the point of interest provided by the disclosure.

As the non-transitory computer readable storage medium, the memory 802 may be configured to store non-transitory software programs, non-transitory computer executable programs and modules, such as program instructions/module (such as the first generating module 601, the second generating module 602, the third generating module 603, the first determining module 604, and the recommending module 605 illustrated in FIG. 6; or the fourth generating module 701, the fifth generating module 702, the sixth generating module 703, the fourth determining module 704, and the adjusting module 705 illustrated in FIG. 7) corresponding to the method for recommending the point of interest according to embodiments of the disclosure. The processor 801 is configured to execute various functional applications and data processing of the server by operating non-transitory software programs, instructions and modules stored in the memory 802, that is, implements the method for recommending the point of interest according to the above method embodiments.

The memory 802 may include a storage program region and a storage data region. The storage program region may store an application required by an operating system and at least one function. The storage data region may store data created according to predicted usage of the electronic device capable of implementing the method for positioning the vehicle based on the semantic representation. In addition, the memory 802 may include a high-speed random access memory, and may also include a non-transitory memory, such as at least one disk memory device, a flash memory device, or other non-transitory solid-state memory device. In some embodiments, the memory 802 may optionally include memories remotely located to the processor 801, and these remote memories may be connected to the electronic device via a network. Examples of the above network include, but are not limited to, an Internet, an intranet, a local area network, a mobile communication network and combinations thereof.

The electronic device capable of implementing the method for recommending the point of interest may also include: an input device 803 and an output device 804. The processor 801, the memory 802, the input device 803, and the output device 804 may be connected via a bus or in other means. In FIG. 8, the bus is taken as an example.

The input device 803 may receive inputted digital or character information, and generate key signal input related to user setting and function control of the electronic device, such as a touch screen, a keypad, a mouse, a track pad, a touch pad, an indicator stick, one or more mouse buttons, a trackball, a joystick and other input device. The output device 804 may include a display device, an auxiliary lighting device (e.g., LED), a haptic feedback device (e.g., a vibration motor), and the like. The display device may include, but be not limited to, a liquid crystal display (LCD), a light emitting diode (LED) display, and a plasma display. In some embodiments, the display device may be the touch screen.

The various implementations of the system and technologies described herein may be implemented in a digital electronic circuit system, an integrated circuit system, an application specific ASIC (application specific integrated circuit), a computer hardware, a firmware, a software, and/or combinations thereof. These various implementations may include: being implemented in one or more computer programs. The one or more computer programs may be executed and/or interpreted on a programmable system including at least one programmable processor. The programmable processor may be a special purpose or general purpose programmable processor, may receive data and instructions from a storage system, at least one input device, and at least one output device, and may transmit data and the instructions to the storage system, the at least one input device, and the at least one output device.

These computing programs (also called programs, software, software applications, or codes) include machine instructions of programmable processors, and may be implemented by utilizing high-level procedures and/or object-oriented programming languages, and/or assembly/machine languages. As used herein, the terms “machine readable medium” and “computer readable medium” refer to any computer program product, device, and/or apparatus (such as, a magnetic disk, an optical disk, a memory, a programmable logic device (PLD)) for providing machine instructions and/or data to a programmable processor, including a machine readable medium that receives machine instructions as a machine readable signal. The term “machine readable signal” refers to any signal for providing the machine instructions and/or data to the programmable processor.

To provide interaction with a user, the system and technologies described herein may be implemented on a computer. The computer has a display device (such as, a CRT (cathode ray tube) or a LCD (liquid crystal display) monitor) for displaying information to the user, a keyboard and a pointing device (such as, a mouse or a trackball), through which the user may provide the input to the computer. Other types of devices may also be configured to provide interaction with the user. For example, the feedback provided to the user may be any form of sensory feedback (such as, visual feedback, auditory feedback, or tactile feedback), and the input from the user may be received in any form (including acoustic input, voice input or tactile input).

The system and technologies described herein may be implemented in a computing system including a background component (such as, a data server), a computing system including a middleware component (such as, an application server), or a computing system including a front-end component (such as, a user computer having a graphical user interface or a web browser through which the user may interact with embodiments of the system and technologies described herein), or a computing system including any combination of such background component, the middleware components and the front-end component. Components of the system may be connected to each other via digital data communication in any form or medium (such as, a communication network). Examples of the communication network include a local area network (LAN), a wide area networks (WAN), and the Internet.

The computer system may include a client and a server. The client and the server are generally remote from each other and generally interact via the communication network. A relationship between the client and the server is generated by computer programs operated on a corresponding computer and having a client-server relationship with each other. The server may be a cloud server, also known as cloud computing server or a cloud host, which is a host product in a cloud computing service system, to solve the defects of difficult management and weak business scalability in a traditional physical host and a VPS service.

According to the technical solution of embodiments of the disclosure, by introducing the POI hierarchical structure and combining the association relationship between the inter-hierarchy candidate POIs and/or intra-hierarchy candidate POIs in the POI hierarchical structure, a sparsity problem caused by information isolation during the POI recommendation for a single hierarchy is avoided, thereby improving accuracy of a POI recommending result. Meanwhile, during the POI recommendation is performed, POIs of multiple hierarchies are recommended in a mixed way, without building a recommending model for the POIs of each hierarchy, thereby improving the comprehensiveness and hierarchy of the POI recommending result.

It should be understood that, steps may be reordered, added or deleted by utilizing flows in the various forms illustrated above. For example, the steps described in the disclosure may be executed in parallel, sequentially or in different orders, so long as desired results of the technical solution disclosed in the disclosure may be achieved, there is no limitation here.

The above detailed implementations do not limit the protection scope of the disclosure. It should be understood by the skilled in the art that various modifications, combinations, sub-combinations and substitutions may be made based on design requirements and other factors. Any modification, equivalent substitution and improvement made within the spirit and the principle of the disclosure shall be included in the protection scope of disclosure.

What is claimed is:

1. A method for recommending a point of interest (POI), comprising:
generating a user explicit feature based on a user profile of a user to be recommended;
generating a POI explicit feature based on a POI profile of each candidate POI in a pre-constructed POI hierarchical structure, wherein a parent POI node at a high hierarchy spatially covers respective child POI nodes at a low hierarchy;
generating a historical interaction feature based on historical interaction behaviors of the user to be recommended to each candidate POI;
determining a matrix of recommending values for each hierarchy based on at least one of the user explicit feature, the POI explicit feature and the historical interaction feature, in combination with an association relationship between inter-hierarchy candidate POIs and/or intra-hierarchy candidate POIs in the POI hierarchical structure; and
selecting at least one target POI from the candidate POIs of each hierarchy for recommendation based on the matrix of recommending values for each hierarchy.

2. The method of claim 1, wherein the matrix of recommending values comprises a matrix of feature recommending values; and
determining the matrix of recommending values for each hierarchy comprises:
determining an inter-hierarchy propagation feature of a current hierarchy based on the POI explicit feature and the historical interaction feature, in combination with a spatial coverage relationship between candidate POIs at adjacent hierarchies in the POI hierarchical structure; and
generating the matrix of feature recommending values based on the user explicit feature, the historical interaction feature and the inter-hierarchy propagation feature.

3. The method of claim 2, wherein the inter-hierarchy propagation feature comprises a POI inter-hierarchy propagation feature; and
determining the inter-hierarchy propagation feature of the current hierarchy comprises:
generating a POI implicit feature based on the historical interaction feature; and
generating a POI inter-hierarchy propagation feature of the parent POI node based on a POI implicit feature of each child POI node in the POI hierarchical structure.

4. The method of claim 3, wherein generating the matrix of feature recommending values comprises:
generating a POI association feature based on the POI explicit feature, the POI implicit feature and the POI inter-hierarchy propagation feature;
generating a user implicit feature based on the historical interaction feature;
generating a user association feature based on the user explicit feature, the user implicit feature and a user inter-hierarchy propagation feature, in which the user inter-hierarchy propagation feature is obtained from the trained user inter-hierarchy propagation parameter; and
generating the matrix of feature recommending values based on the POI association feature and the user association feature.

5. The method of claim 3, wherein generating the POI inter-hierarchy propagation feature of the parent POI node comprises:
determining a propagation weight of each child POI node based on the POI implicit feature of the child POI node associated with the parent POI node in the POI hierarchical structure; and
determining the POI inter-hierarchy propagation feature of the parent POI node based on the propagation weight and the POI implicit feature of each child POI node.

6. The method of claim 1, wherein the matrix of recommending values comprises a matrix of historical recommending values; and
determining the matrix of recommending values for each hierarchy comprises:
determining a spatial influence feature of each hierarchy respectively based on the POI explicit feature and the historical interaction feature, in combination with a similar relationship between candidate POIs at the same hierarchy in the POI hierarchical structure; and
generating the matrix of historical recommending values based on the user explicit feature and the spatial influence feature.

7. The method of claim 6, wherein determining the spatial influence feature of each hierarchy respectively comprises:
for each of the candidate POIs at the same hierarchy in the POI hierarchical structure, determining a similar POI having the similar relationship with the candidate POI based on the historical interaction feature;
determining a spatial influence vector of each candidate POI based on a POI explicit feature of the similar POI; and
generating the spatial influence feature of the hierarchy based on the spatial influence vector of each candidate POI at the same hierarchy.

8. The method of claim 7, wherein generating the matrix of historical recommending values comprises:
generating a POI preference vector based on the user explicit feature and the spatial influence feature; and
generating the matrix of historical recommending values based on the POI preference vector.

9. The method of claim 6, wherein the similar relationship comprises at least one of an associated search relationship, an associated visiting relationship and a spatial adjacent relationship.

10. The method of claim 4, further comprising:
obtaining a POI hierarchy propagation vector of each child POI node of the target POI in the POI inter-hierarchy propagation feature;
obtaining a user hierarchy propagation vector of the user to be recommended in the user inter-hierarchy propagation feature; and
determining an importance of each child POI node based on the POI hierarchy propagation vector and the user hierarchy propagation vector.

11. The method of claim 8, further comprising:
obtaining a preference value of each historical interaction POI in the POI preference vector; and
determining a spatial influence of the target POI based on a ratio of a preference value of the target POI to a sum of the preference values of historical interaction POIs.

12. A method for recommending a point of interest (POI), comprising:
generating a sample user explicit feature based on a user profile of a sample user;
generating a sample POI explicit feature based on a POI profile of each candidate sample POI in a pre-constructed POI hierarchical structure, wherein a parent POI node space at a high hierarchy spatially covers respective child POI nodes at a low hierarchy;
generating a sample historical interaction feature based on historical interaction behaviors of the sample user to each candidate sample POI;
determining a sample matrix of recommending values for each hierarchy by inputting at least one of the sample user explicit feature, the sample POI explicit feature and the sample historical interaction feature to a pre-constructed POI recommending model, in combination with an association relationship between inter-hierarchy candidate sample POIs and/or intra-hierarchy candidate POIs in the POI hierarchical structure; and
adjusting a network parameter in the pre-constructed POI recommending model based on the sample historical interaction feature and the sample matrix of recommending values.

13. The method of claim 12, wherein adjusting the network parameter in the pre-constructed POI recommending model based on the sample historical interaction feature and the sample matrix of recommending values comprises:
determining a first candidate sample POI and a second candidate sample POI of the sample user based on the sample historical interaction feature; and
adjusting the network parameter in the pre-constructed POI recommending model based on a predicted difference between a predicted recommending value of the first candidate sample POI and a predicted recommending value of the second candidate sample POI in the sample matrix of recommending values.

14. An apparatus for recommending a point of interest (POI), comprising:
at least one processor; and
a memory configured to store instructions executable by the at least one processor,
wherein the at least one processor is configured to:
generate a user explicit feature based on a user profile of a user to be recommended;
generate a POI explicit feature based on a POI profile of each candidate POI in a pre-constructed POI hierarchical structure, wherein a parent POI node space at a high hierarchy spatially covers respective child POI nodes at a low hierarchy;
generate a historical interaction feature based on historical interaction behaviors of the user to be recommended to each candidate POI;
determine a matrix of recommending values for each hierarchy based on at least one of the user explicit feature, the POI explicit feature and the historical interaction feature, in combination with an association relationship between inter-hierarchy candidate POIs and/or intra-hierarchy candidate POIs in the POI hierarchical structure; and
select at least one target POI from the candidate POIs of each hierarchy for recommendation based on the matrix of recommending values for each hierarchy.

15. The apparatus of claim 14, wherein the matrix of recommending values comprises a matrix of feature recommending values; and the at least one processor is further configured to:
determine an inter-hierarchy propagation feature of a current hierarchy based on the POI explicit feature and the historical interaction feature, in combination with a spatial coverage relationship between candidate POIs at adjacent hierarchies in the POI hierarchical structure; and
generate the matrix of feature recommending values based on the user explicit feature, the historical interaction feature and the inter-hierarchy propagation feature;
wherein the inter-hierarchy propagation feature comprises a POI inter-hierarchy propagation feature; and the at least one processor is further configured to: generate a POI implicit feature based on the historical interaction feature; and generate a POI inter-hierarchy propagation feature of the parent POI node based on a POI implicit feature of each child POI node in the POI hierarchical structure.

16. The apparatus of claim 15, wherein the at least one processor is further configured to:
generate a POI association feature based on the POI explicit feature, the POI implicit feature and the POI inter-hierarchy propagation feature;
generate a user implicit feature based on the historical interaction feature;
generate a user association feature based on the user explicit feature, the user implicit feature and a user inter-hierarchy propagation feature, in which the user inter-hierarchy propagation feature is obtained from the trained user inter-hierarchy propagation parameter; and
generate the matrix of feature recommending values based on the POI association feature and the user association feature.

17. The apparatus of claim 15, wherein the at least one processor is further configured to:
determine a propagation weight of each child POI node based on the POI implicit feature of the child POI node associated with the parent POI node in the POI hierarchical structure; and
determine the POI inter-hierarchy propagation feature of the parent POI node based on the propagation weight and the POI implicit feature of each child POI node.

18. The apparatus of claim 14, wherein the matrix of recommending values comprises a matrix of historical recommending values; and the at least one processor is further configured to:
determine a spatial influence feature of each hierarchy respectively based on the POI explicit feature and the historical interaction feature, in combination with a similar relationship between candidate POIs at the same hierarchy in POI hierarchical structure, wherein the similar relationship comprises at least one of an associated search relationship, an associated visiting relationship and a spatial adjacent relationship; and
generate the matrix of historical recommending values based on the user explicit feature and the spatial influence feature;
wherein the at least one processor is further configured to:
for each of the candidate POIs at the same hierarchy in the POI hierarchical structure, determine a similar POI having the similar relationship with the candidate POI based on the historical interaction feature;
determine a spatial influence vector of each candidate POI based on a POI explicit feature of the similar POI; and
generate the spatial influence feature of the hierarchy based on the spatial influence vector of each candidate POI at the same hierarchy.

19. The apparatus of claim 18, wherein the at least one processor is further configured to:
generate a POI preference vector based on the user explicit feature and the spatial influence feature;
generate the matrix of historical recommending values based on the POI preference vector;
obtain a preference value of each historical interaction POI in the POI preference vector; and
determine a spatial influence of the target POI based on a ratio of a preference value of the target POI to a sum of the preference values of respective historical interaction POIs.

20. The apparatus of claim 16, wherein the at least one processor is further configured to:
obtain a POI hierarchy propagation vector of each child POI node of the target POI in the POI inter-hierarchy propagation feature;
obtain a user hierarchy propagation vector of the user to be recommended in the user inter-hierarchy propagation feature; and
determine an importance of each child POI node based on the POI hierarchy propagation vector and the user hierarchy propagation vector.
